(19) United States
(12) Patent Application Publication
(10) Pub. No.: US 2006/0047763 A1
(43) Pub. Date: Mar. 2, 2006

(54) Rapid email reading system and method of combining multiple electronic mailboxes and a short message

(75) Inventor: Jyun-Naih Lin, Taipei City (TW)

Correspondence Address: BACON & THOMAS, PLLC, 625 SLATERS LANE, FOURTH FLOOR, ALEXANDRIA, VA, 22314, US

(73) Assignee: Institute For Information Industry, Taipei City (TW)

(21) Appl. No.: 10/986,304

(22) Filed: Nov. 12, 2004

(30) Foreign Application Priority Data
Aug. 31, 2004 (TW) 093126180

(51) Int. Cl. G06F 15/16

(52) U.S. Cl. 709/206

(57) ABSTRACT

An email reading system and method of combining multiple electronic mailboxes and a short message, which has at least one Internet mail server, an Internet message gateway and at least one handheld device. The message gateway applies the POP3 protocol for sending a command of processing email to the mail server, checks corresponding electronic mails (emails) in the mailboxes on the at least one mail server in accordance with a predetermined interval and filters the emails in accordance with a predetermined search condition, such that when one or more of the emails meet the search condition, the message gateway sends a short message to the handheld device. Accordingly, the user can send a short message command to the message gateway through the handheld device for accessing or deleting the one or more emails.

### BACKGROUND OF THE INVENTION

1. Field of the Invention

The invention relates to an email reading system and method of combining multiple electronic mailboxes and a short message and, more particularly, to a rapid email reading system and method using a handheld device to access emails from multiple electronic mailboxes, and also a short message.

2. Description of Related Art

Electronic mail service among all functions of the Internet is mostly used and well known, which provides a simple, rapid method to deliver emails to a user electronic mailbox on another remote mail server through the Internet. Also, since mobile communications have rapidly developed, mobile networks are increasingly popular. People desire that the mobile networks can provide not only voice services but also the Internet services, such as emails in electronic mailboxes assigned by a user can be browsed by a handheld device (mobile phone), thereby achieving the purpose of accessing data wherever.

However, conventional mobile network system providers (such as Nokia) mostly use the respective specific mailboxes (such as Nokia One mailbox, Hinet mailbox or Hotmail mailbox). A user cannot set randomly for electronic mail (email) check and read of a certain Post Office Protocol 3 (POP3) mail host on the Internet. In addition, a mobile network system in conjunction of mail servers requires a lot of memory space to store a user's emails, or has not functions of filtering certain senders and subjects. Email search mostly compares a sender and the sending time, other than the message-ID of a mail header. Accordingly, special emails cannot be effectively and accurately extracted.

Therefore, it is desirable to provide an improved system and method to mitigate and/or obviate the aforementioned problems.

### SUMMARY OF THE INVENTION

The object of the invention is to provide a rapid email reading system and method of combining multiple assigned electronic mailboxes and a short message, which can overcome the problems in the prior art that a communication provider provides only with reading emails of a specific electronic mailbox or certain emails cannot be filtered.

In accordance with one aspect of the present invention, there is provided a rapid email reading system of combining multiple assigned electronic mailboxes and a short message. The rapid email reading system essentially includes at least one Internet mail server, an Internet message gateway and at least one handheld device. The Internet message gateway with a mobile transceiver transmits and receives a mobile signal through a mobile channel, or communicates with an SMSC/MMSC server capable of transmitting and receiving a short message through the Internet to thus transmit and receive the mobile signal, and applies the POP3 protocol to the at least one mail server for sending a command of processing email. The at least one handheld device uses the mobile channel to transmit the commands to and receive the messages from the message gateway. The at least one mail server has an electronic mailbox with respect to the commands. The message gateway checks emails in the electronic mailbox through the POP3 protocol in accordance with a predetermined interval and filters the emails in accordance with a predetermined search condition. When a new email among the emails meets the search condition, the message gateway sends a short message with a special sequence number representing the new email to the handheld device.

In accordance with another aspect of the present invention, there is provided a rapid email reading method of combining multiple assigned electronic mailboxes and a short message. The multiple electronic mailboxes are located in at least one mail server on the Internet. An Internet message gateway sends a command of processing email to the at least one mail server. The rapid email reading method essentially includes the steps of: (A) using the message gateway to check electronic mails (emails) in the electronic mailboxes on the at least one mail server in accordance with a predetermined interval; (B) using the message gateway to filter the emails in accordance with a predetermined search condition; and (C) using the message gateway to send a short message with a special sequence number representing the new email to a handheld device when a new email among the emails meets the search condition.

Other objects, advantages, and novel features of the invention will become more apparent from the following detailed description when taken in conjunction with the accompanying drawings.

### BRIEF DESCRIPTION OF THE DRAWINGS

FIG. 1 is a configuration of a rapid email reading system of combining multiple electronic mails (emails) and a short message in accordance with the invention;

FIG. 2 is a flowchart of a rapid email reading method of combining multiple electronic mails (emails) and a short message in accordance with the invention;

FIG. 3 is a table of POP3-associated commands used to access emails in accordance with the invention;

FIG. 4 is a descriptive representation of a mail header of an electronic mail in accordance with the invention;

FIG. 5 is a schematic graph of FIG. 1 plus a message table in accordance with the invention;

FIG. 6 is a schematic graph of email reading in accordance with the invention;

FIG. 7 is a flowchart of email reading in accordance with the invention;

FIG. 8 is a schematic graph of email deletion in accordance with the invention; and

FIG. 9 is a flowchart of email deletion in accordance with the invention.

### DETAILED DESCRIPTION OF THE PREFERRED EMBODIMENT

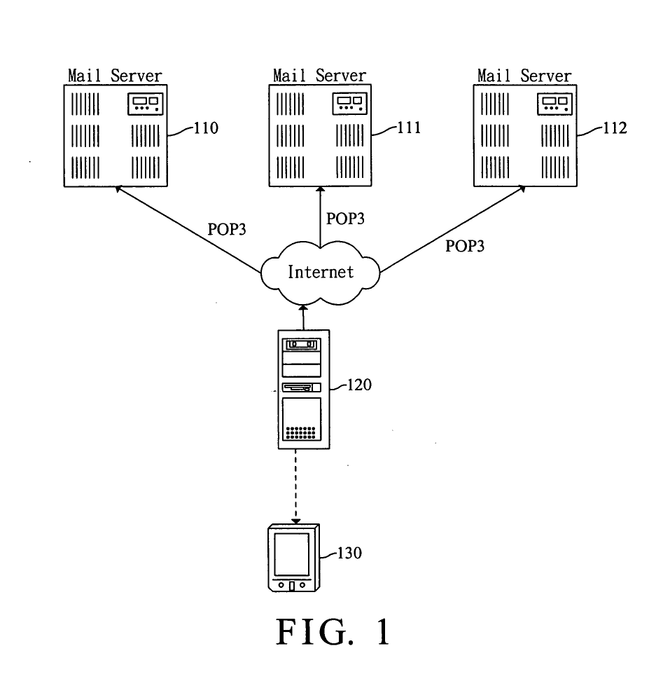

FIG. 1 is a configuration of a rapid email reading system of combining multiple electronic mails (emails) and a short message in accordance with the invention. As shown, the system includes three Internet mail servers 110-112, which are connected to the Internet, an Internet message gateway 120 connected to the Internet, and at least one handheld device 130 communicating with the message gateway 120 over-the-air. The POP3 protocol is applied to access emails between the message gateway 120 and the mail servers 110-112. The message gateway 120 has a mobile transceiver to receive and transmit a wireless signal through a mobile channel and applies the POP3 protocol to the mail servers 110-112 for sending a command to access corresponding emails. The handheld device 130 uses the mobile channel to receive the message and transmit the command. One or more of the mail servers 110-112 have an electronic mailbox respectively with respect to the handheld device 130. The message gateway 120 checks emails in the electronic mailbox with respect to the command through the POP3 protocol in accordance with a predetermined interval set by a user, and filters the emails in accordance with a predetermined search condition set by the user. Thus, when a new email meets the search condition, the message gateway 120 sends a short message to the at least one handheld device 130. Accordingly, the device 130 can use short message commands to rapidly read or delete the email through the message gateway 120.

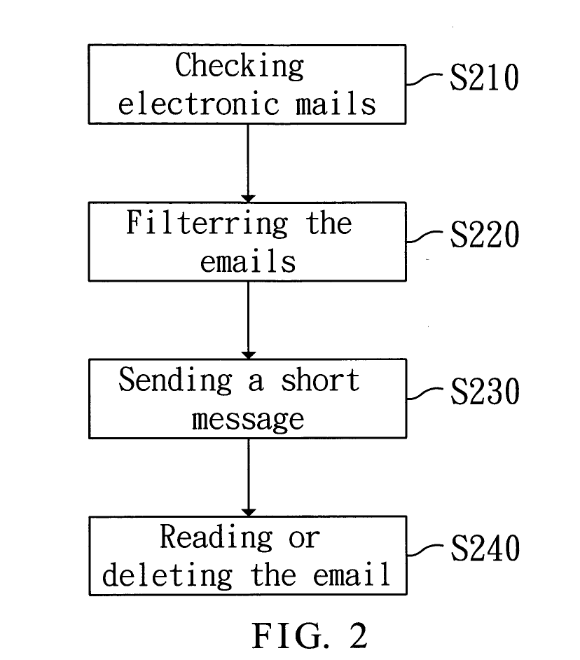

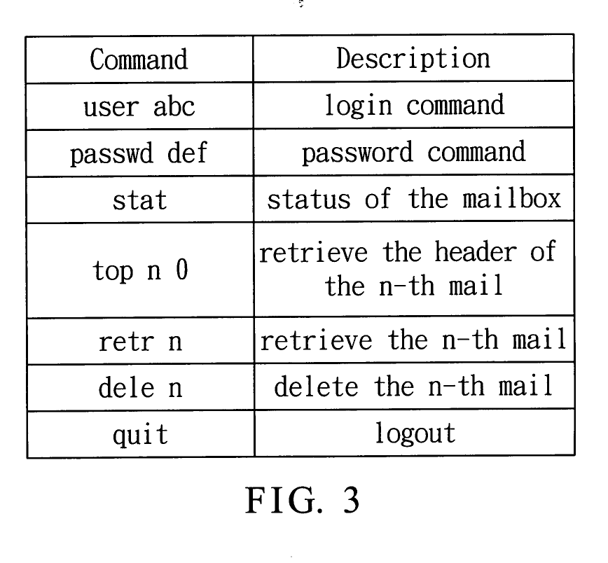

FIG. 2 is a flowchart of a rapid email reading method of combining multiple electronic mails and a short message in accordance with the invention. In this embodiment, a user has three different electronic mailboxes respectively located in the mail servers 110-112 and applies the handheld device 130 for rapidly accessing emails in the electronic mailboxes through the message gateway 120. The handheld device 130 can be a mobile phone, a personal digital assistant (PDA) with a function of mobile network access or the like. In step S210, the message gateway 120 applies the POP3 protocol for checking all emails in the electronic mailboxes respectively on the mail servers 110-112 used by the user in accordance with the predetermined interval set by the user. FIG. 3 is a table of POP3-associated commands used to access the emails as cited above. In this case, the user sets the message gateway 120 to apply the POP3-associated commands for checking the three electronic mailboxes once every 60 minutes.

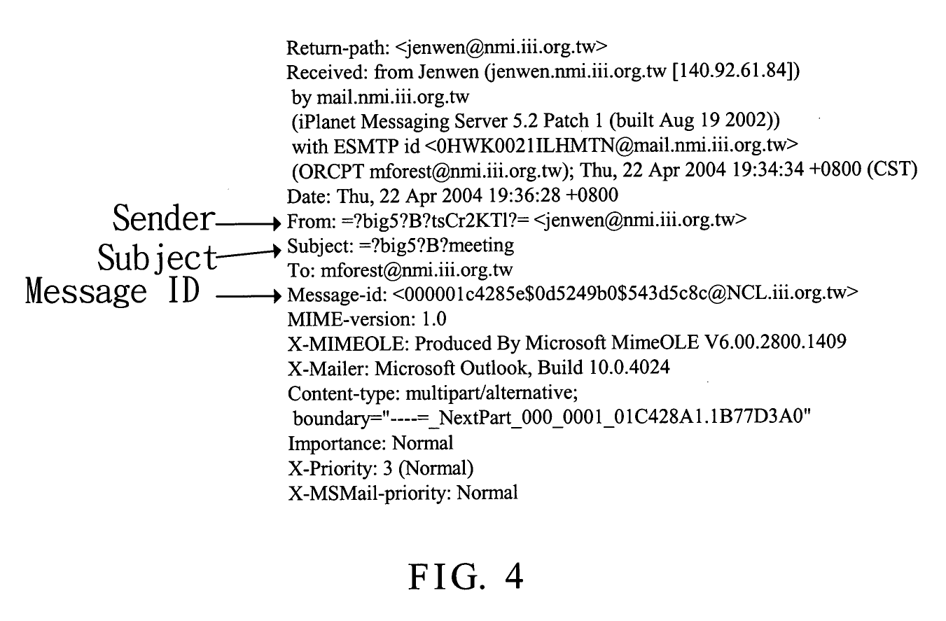

In step S220, the message gateway 120 filters some fields of the email headers associated with the search condition. FIG. 4 is a descriptive representation of a mail header of an email in accordance with the invention. As shown in FIG. 4, the mail header includes a sender field, a subject field and a message-ID field. The user may set a sender of ylwu117@yahoo.com.tw or jenwen@nmi.iii.org.tw or a subject with a ‘meeting’ pattern as a search condition. Accordingly, the message gateway 120 filters the fields of the mail headers in the electronic mailboxes respectively on the mail servers 110-112, thereby saving the message-ID fields that meet the search condition as a message table 510.

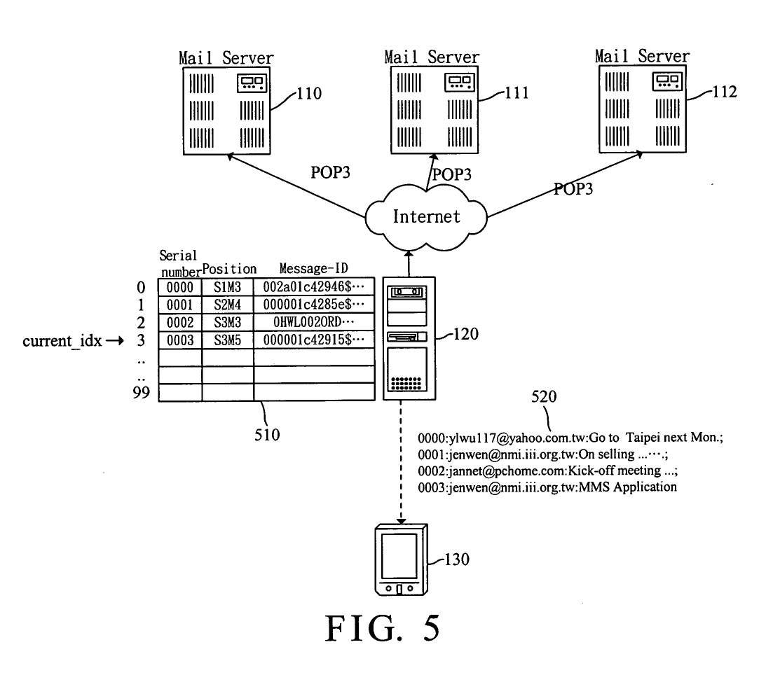

FIG. 5 is a schematic graph of FIG. 1 plus the message table 510 in accordance with the invention. As shown in FIG. 5, the message table 510 has a serial number field, a position field and a message-ID field. In this case, after filtered, a third email on the mail server 110, a fourth email on the mail server 111 and a third and a fifth emails on the mail server 112 meet the search condition of either ylwu117@yahoo.com.tw, jenwen@nmi.iii.org.tw or a subject with a ‘meeting’ pattern. Thus, the message gateway 120 saves the corresponding position SxMy into the position field of the message table 510, where Sx indicates a x-th mail server and My indicates a y-th mail in the x-th mail server's mailbox. The message gateway 120 also records the corresponding message-IDs of the mail headers that meet the search condition into the message-ID field. The message-ID can be recorded by previous n characters or letters such as previous 30 letters.

The message gateway 120 uses a current index current_idx to access the message table 510. The current_idx starts at zero. As checking mailboxes set by the user each time so as to find a new email to be noticed, the message gateway 120 places data associated with the new email to a next table entry indicated by the current_idx, and adds the current_idx by one. When the current_idx has a value over a total of table entries, the first table entry is reused, i.e., the current_idx is reset to zero.

The message gateway 120 gives each record a special serial number. The special serial numbers are numbered as a leading number plus a table entry number each. Such numbers are numbers to notice the user. In this case, the leading number and the table entry number respectively have two digits from 00 to 99. As the current_idx returns to the first table entry because it exceeds the total of table entries, the leading number is added by one. Also, the leading number returns to 00 as it exceeds 99. Accordingly, the serial number is from 0000 to 9999. For example, a serial number xx02 indicates that corresponding data is placed in the second entry of the message table 510. The serial numbers xx02 and yy02 indicate different emails. Upon the special serial numbers for recording data in the message table 510, the message gateway 120 can use direct mapping to rapidly find the position of a desired email.

When the message gateway 120 finds that a current email has a serial number recorded in the message table 510 that indexes to a different position from its actual position stored in the mailbox, the position is corrected as the actual position. For example, in the mail server 110, as a third email is shifted to a second email, the position field recorded in the message table 510 is changed from S1M3 to S1M2.

For each mailbox check, if a new email that meets the search condition is found by comparing the message-ID fields, the new email is recorded in the message table 510 and a short message (SMS) 520 is sent to the handheld device 130 for notice. The short message 520 has a format as ‘serial number:sender account:subject’. The message gateway 120 combines such email notices as many as possible into a short message, thereby saving required communication cost (step S230).

In step S240, after the short message is received, the user can send a read command or a delete command through the handheld device 130. The read command is equal to the serial number that the user is noticed by the message gateway 120. The delete command is equal to a ‘D’ or ‘d’ plus the serial number. Therefore, the new email is read or deleted by the user who uses the handheld device 130 to send the read command or the delete command to a representative number of the message gateway 120.

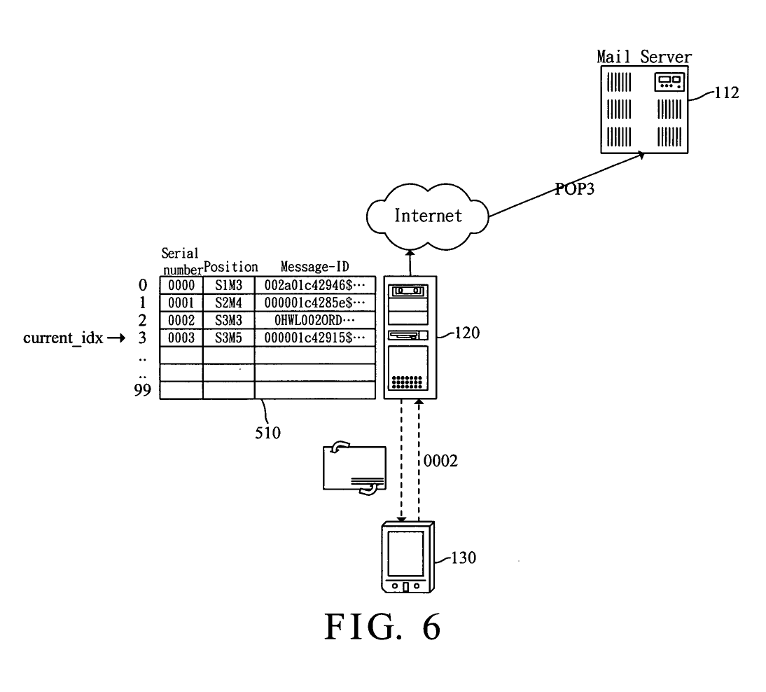

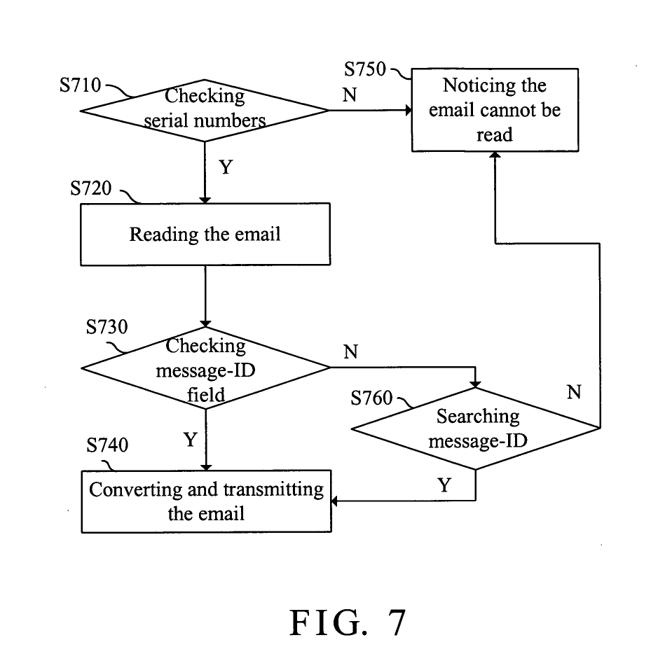

FIG. 6 is a schematic graph of email read in accordance with the invention, which shows that the user desires to read a third email, located on the mail server 112, with a serial number of 0002 in accordance with the message table 510. FIG. 7 is a flowchart of the email read of FIG. 6 in accordance with the invention. As shown in FIG. 7, in step S710, the message gateway 120 checks if the received and the recorded serial numbers are identical in accordance with a read command sent by the user. In this case, since the read command has the serial number of 0002 given by the message gateway 120, the message gateway 120 accordingly uses both the table entry number of the serial number and the direct mapping to easily find the table entry number 2 (entry 2) for comparison.

If the comparison is identical, it indicates that the serial number of the read command is contained in the message table 510, thus on which mail server and at which number of the third email stored can be found through the position field (S3M3) recorded by the entry. In this embodiment, the third email to be read by the user is stored in the third email of the mail server 112. The message gateway 120 accordingly connects the mail server 112 for reading the header of the third email through the POP3 protocol (step 720).

Step S730 checks if the message-ID field of the mail header on the position S3M3 recorded by the entry is identical to the message-ID field of the mail header in the message table 510. If yes, it indicates that the third email of the mail server 112 is the right one to be read by the user. The message gateway 120 then converts it into a message format receivable of the handheld device 130 for transfer (step S740).

In step S710, if the serial numbers are different, it indicates that the third email to be read does not exist in the records of any mail server, thus a notice of email missing is sent to the handheld device 130 (step S750) to notice the user that the third email cannot be read. In step S730, if the message-IDs checked are different, it indicates that the message gateway 120 cannot find the message-ID at the position recorded by the message table 510, thus step S760 is performed. In step S760, the message gateway 120 searches the mailbox starting with the position S3M3 of the third email backward (from the third one to the first one), because a new email is placed at the last. If the message-ID identical is found in the mailbox, the message gateway 120 extracts the email with the message-ID from the mailbox, sends it to the user after converted, and replaces the recorded position (S3M3) in the message table 510 with the position currently extracted (step S740). If the third email cannot be found after the backward search is complete, it indicates that the third email to be read does not exist in the records of any mail server, thus a notice of email missing is sent to the handheld device 130 (step S750) to notice that the user cannot read the third email. Further, the message gateway 120 deletes the email record from the message table 510.

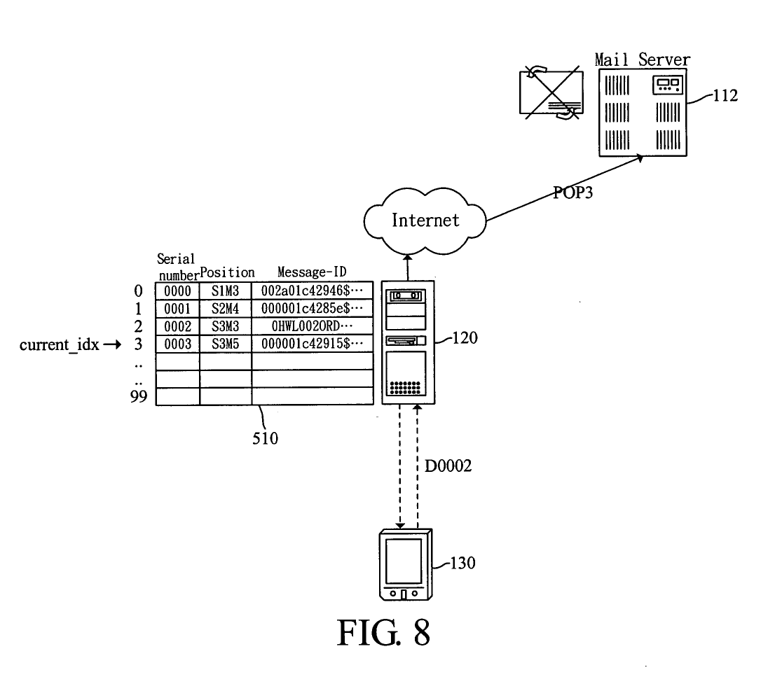

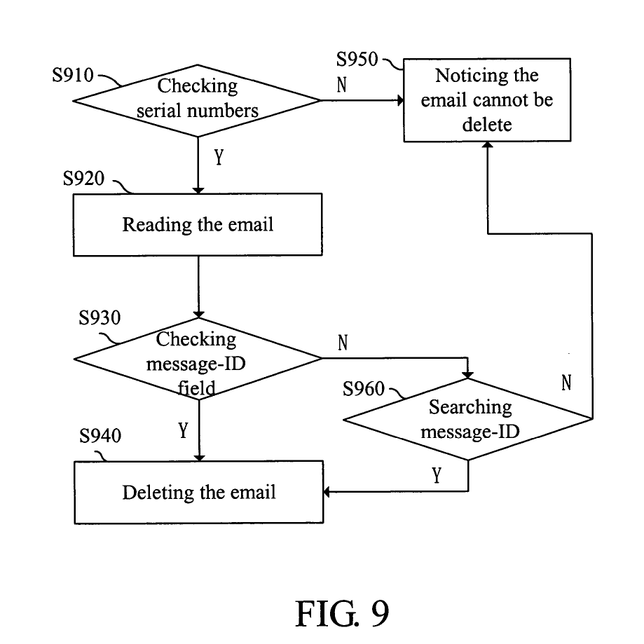

FIG. 8 is a schematic graph of email deletion in accordance with the invention, which shows that a user desires to delete a third email, located on the mail server 112, with a serial number of 0002 in accordance with the message table 510. FIG. 9 is a flowchart of email delete in accordance with the invention. As shown in FIG. 9, in step S910, the message gateway 120 checks if the received and the recorded serial numbers are identical in accordance with a delete command sent by the user. In this case, since the delete command has the serial number of 0002 given by the message gateway 120, the message gateway 120 accordingly uses both the table entry number of the serial number and the direct mapping to easily find the table entry number 2 (entry 2) for comparison.

If the comparison is identical, it indicates that the serial number of the delete command is contained in the message table 510, thus on which mail server and at which number of the third email stored can be found through the position field (S3M3) recorded by the entry. In this embodiment, the third email to be read by the user is stored in the third email of the mail server 112. The message gateway 120 accordingly connects the mail server 112 for reading the header of the third email through the POP3 protocol (step 920).

Step S930 checks if the message-ID field of the mail header on the position S3M3 recorded by the entry is identical to the message-ID field of the mail header in the message table 510. If yes, it indicates that the third email of the mail server 112 is the right one to be deleted by the user. The message gateway 120 then deletes it from the mail server 112 through the POP3 protocol and notices the user that the third email is deleted, and also deletes the record from the message table 510 (step S940).

In step S910, if the serial numbers are different, the result that the third email cannot be deleted is noticed to the user through the handheld device 130 (step S950). In step S930, if the message-IDs checked are different, it indicates that the message gateway 120 cannot find the message-ID at the position recorded by the message table 510, thus step S960 is performed. In step S960, the message gateway 120 searches the mailbox starting with the position S3M3 of the third email backward (from the third one to the first one), because a new email is placed at the last. If the message-ID identical is found in the mailbox, the message gateway 120 deletes the email with the message-ID from the mailbox, notices the user that the third email is deleted (step S940). If the third email cannot be found after the backward search is complete, it indicates that the third email to be deleted does not exist in the records of any mail server, thus a notice of email missing is sent to the handheld device 130, and the message gateway 120 deletes the email record from the message table 510 (step S950).

In view of the foregoing, the inventive rapid email reading system and method of combining multiple mailboxes and a short message can check and filter multiple mailboxes set by the user through the POP3 protocol in accordance with a predetermined interval and sender or a subject, which can overcome the prior problems cited above. In addition, the invention uses the special serial numbers for rapidly finding the position of a desired email, and a short message to notice the user a new email's serial number, sender and subject, thus the user can use the short message command to read or delete the email.

Although the present invention has been explained in relation to its preferred embodiment, it is understood that many other possible modifications and variations can be made without departing from the spirit and scope of the invention as hereinafter claimed.

What is claimed is:

1. An email reading system of combining multiple electronic mailboxes and a short message, essentially comprising:
at least one Internet mail server;
an Internet message gateway with a mobile transceiver, which transmits and receives a mobile signal through a mobile channel or communicates with an SMSC/MMSC server capable of transmitting and receiving short message through the Internet to thus transmit and receive the mobile signal through the SMSC/MMSC server, and applies an Internet protocol to the at least one mail server for sending a command of processing email; and
at least one handheld device, which uses the mobile channel to receive a short message for an email notice and transmit the command of processing email through the message gateway to a respective electronic mailbox of the mail server;
wherein the message gateway checks emails in the electronic mailbox through the Internet protocol in accordance with a predetermined interval and filters the emails in accordance with a predetermined search condition, such that when a new email among the emails meets the search condition, the message gateway sends the short message to the handheld device.

2. The reading system as claimed in claim 1, wherein the message gateway applies the POP3 protocol for sending the command.

3. The reading system as claimed in claim 1, wherein the search condition has email senders or keywords of email subjects.

4. The reading system as claimed in claim 1, wherein the short message sent to the handheld device has serial numbers, email senders and subjects.

5. The reading system as claimed in claim 1, wherein the handheld device uses short message commands to read or delete the new email through the message gateway.

6. The reading system as claimed in claim 1, wherein the message gateway has a message table to record corresponding fields of all emails meeting with the search condition.

7. The reading system as claimed in claim 6, wherein the fields have a serial number field, a position field and a message-ID field.

8. The reading system as claimed in claim 7, wherein the position field records corresponding positions of the emails in the mail server.

9. The reading system as claimed in claim 7, wherein the message-ID field records corresponding message-IDs of mail headers of the emails.

10. An email reading method of combining multiple electronic mailboxes and a short message, wherein the multiple electronic mailboxes are located in at least one mail server on the Internet, and a command of processing email is sent by an Internet message gateway through the at least one mail server to the mailboxes, the method essentially comprising the steps:
(A) using the message gateway to check electronic mails (emails) in the electronic mailboxes on the at least one mail server in accordance with a predetermined interval;
(B) using the message gateway to filter the emails in accordance with a predetermined search condition;
(C) using the message gateway to send a short message to a handheld device when a new email among the emails meets the search condition; and
(D) using the handheld device to read or delete the new email in accordance with a short message through the message gateway.

11. The reading method as claimed in claim 10, wherein in step (A), the message gateway applies the POP3 protocol for sending the command of processing email.

12. The reading method as claimed in claim 10, wherein in step (B), the search condition has email senders or keywords of email subjects.

13. The reading method as claimed in claim 10, wherein in step (C), the short message sent to the handheld device has serial numbers, email senders and subjects.
